(19) United States
(12) Patent Application Publication
(10) Pub. No.: US 2007/0171280 A1
(43) Pub. Date: Jul. 26, 2007

(54) INVERSE TELECINE ALGORITHM BASED ON STATE MACHINE

(75) Inventors: Tao Tian, San Diego, CA (US); Fang Liu, San Diego, CA (US); Vijayalakshmi R. Raveendran, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/550,752

(22) Filed: Oct. 18, 2006

Related U.S. Application Data
(60) Provisional application No. 60/730,145, filed on Oct. 24, 2005.

(51) Int. Cl. H04N 11/20; H04N 7/01; H04N 5/253

(52) U.S. Cl. 348/97; 348/441

(57) ABSTRACT

A technique for processing video to determine which segments of video originate in a telecine and which conform to the NTSC standard is described herein. The current pull-down phase of the 3:2 pull-down (see below) in a telecine generated video segment is estimated and used to invert the telecine process.

### CLAIM OF PRIORITY UNDER 35 U.S.C. §119

The Application for Patent claims priority to Provisional Application No. 60/730,145 entitled “Inverse Telecine Algorithm Based on State Machine” filed Oct. 24, 2005, and assigned to the assignee hereof and hereby expressly incorporated by reference herein.

### FIELD

This system incorporates procedures for distinguishing between telecine originated video and conventionally generated broadcast video. Following that decision, data derived from the decision process facilitates the reconstruction of the film images that were telecined.

### BACKGROUND

In the 1990's television technology switched from using analog methods for representing and transmitting video to digital methods. Once it was accepted that the existing solid state technologies would support new methods for processing video, the benefits of digital video were quickly recognized. Digital video could be processed to match various types of receivers having different numbers of lines, and line patterns that were either interlaced or progressive. The cable industry welcomed the opportunity to change the bandwidth-resolution tradeoff virtually on the fly, allowing up to twelve video channels or 7-8 channels of digital video that had superior picture quality to be transmitted in a bandwidth that formerly carried one analog channel of video. Digital pictures would no longer be affected by ghosts caused by multipath in transmission.

The new technology offered the possibility of high definition television (HDTV), having a cinema-like image and a wide screen format. Unlike the current aspect ratio that is 4:3, the aspect ratio of HDTV is 16:9, similar to a movie screen. HDTV can include Dolby Digital surround sound, the same digital sound system used in DVDs and many movie theaters. Broadcasters could choose either to transmit either a high resolution HDTV program or send a number of lower resolution programs in the same bandwidth. Digital television could also offer interactive video and data services.

There are two underlying technologies that drive digital television. The first technology uses transmission formats that take advantage of the higher signal to noise ratios typically available in channels that support video. The second is the use of signal processing to remove unneeded spatial and temporal redundancy present in a single picture or in a sequence of pictures. Spatial redundancy appears in pictures as relatively large areas of the picture that have little variation in them. Temporal redundancy refers to structures in a picture that reappear in later or earlier pictures. The signal processing operations are best performed on frames or fields that are all formed at the same time, and are not composites of picture elements that are scanned at different times. The NTSC compatible fields formed from cinema images by a telecine have an irregular time base that must be corrected for ideal compression to be achieved. However, video formed in telecine may be intermixed with true NTSC video that has a different underlying time base. Effective video compression is a result of using the properties of the video to eliminate redundancy. Therefore there is a need for a technique that automatically would distinguish telecined video from true interlaced NTSC video, and, if telecined video is detected, invert the telecining process, recovering the cinematic images that were the source of the telecined video.

### SUMMARY

One aspect of this aspect comprises a method for processing video frames that comprises determining a plurality of metrics from said video frames, and inverse telecining said video frames using the determined metrics.

Yet another aspect of this aspect comprises an apparatus for processing video frames comprising a computational module configured to determine a plurality of metrics from said video frames, and a phase detector configured to provide inverse telecine of said video frames using the determined metrics.

Yet another aspect of this aspect comprises an apparatus for processing video frames that comprises a means for determining a plurality of metrics from said video frames, and a means for inverse telecining said video frames using the determined metrics.

Yet another aspect of this aspect comprises a machine readable medium for processing digitized video frames, that comprises instructions that upon execution cause a machine to determine a plurality of metrics from said video data, and inverse telecine the video frames using the determined metrics.

Yet another aspect of this aspect comprises a video compression processor configured to determine a plurality of metrics from a plurality of video frames, and inverse telecine the video frames using the determined metrics.

### BRIEF DESCRIPTION OF THE DRAWINGS

FIG. 1 is a block diagram illustrating a video transmission system.

FIG. 2 is a block diagram illustrating further aspects of components of FIG. 1.

FIG. 3A is a flowchart illustrating a process of inverting telecined video.

FIG. 3B is a block that exhibits the structure of the system for inverse telecining.

FIG. 4 is a phase diagram.

FIG. 5 is a guide to identify the respective frames that are used to create a plurality of matrices.

FIG. 6 is a flowchart illustrating how the metrics of FIG. 5 are created.

FIG. 7 is a trellis showing possible phase transitions.

FIG. 8 is a flowchart which shows the processing of the metrics to arrive at an estimated phase.

FIG. 9 is a dataflow diagram illustrating a system for generating decision variables.

FIG. 10 is a block diagram depicting variables that are used to evaluate the branch information.

FIGS. 11A, 11B and 11C are flowcharts showing how lower envelopes are computed.

FIG. 12 is a flowchart showing the operation of a consistency detector.

FIG. 13 is a flowchart showing a process of computing an offset to a decision variable that is used to compensate for inconsistency in phase decisions.

FIG. 14 presents the operation of inverse telecine after the pull down phase has been estimated.

### DETAILED DESCRIPTION

The following detailed description is directed to certain specific aspects of the invention. However, the invention can be embodied in a multitude of different ways as defined and covered by the claims. In this description, reference is made to the drawings wherein like parts are designated with like numerals throughout.

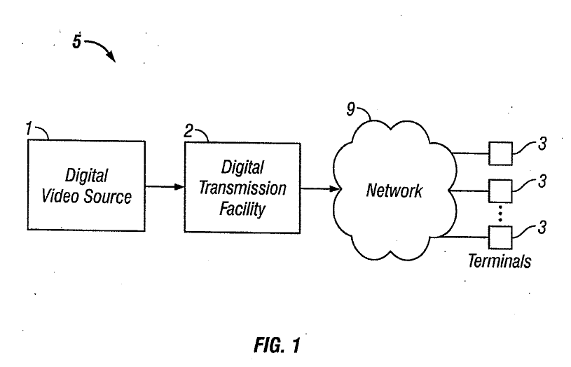

FIG. 1 is a functional block diagram of a transmission system 5 which supports the digital transmission of compressed video to a plurality of terminals. The transmission system 5 includes a source of digital video 1, which might be a digital cable feed or an analog high signal/ratio source that is digitized. The video 1 may be compressed in the transmission facility 2 and there modulated onto a carrier for transmission through the network 9 to terminals 3.

Video compression gives best results when the properties of the source are known and used to select the ideally matching form of processing. Off-the-air video, for example, can originate in several ways. Broadcast video that is conventionally generated—in video cameras, broadcast studios etc.—conforms in the United States to the NTSC standard. According the standard, each frame is made up of two fields. One field consists of the odd lines, the other, the even lines. This may be referred to as an “interlaced” format. While the frames are generated at approximately 30 frames/sec, the fields are records of the television camera's image that are 1/60 sec apart. Film on the other hand is shot at 24 frames/sec, each frame consisting of a complete image. This may be referred to as a “progressive” format. For transmission in NTSC equipment, “progressive” video is converted into “interlaced” video format via a telecine process. In one aspect, further discussed below, the system advantageously determines when video has been telecined and performs an appropriate transform to regenerate the original progressive frames.

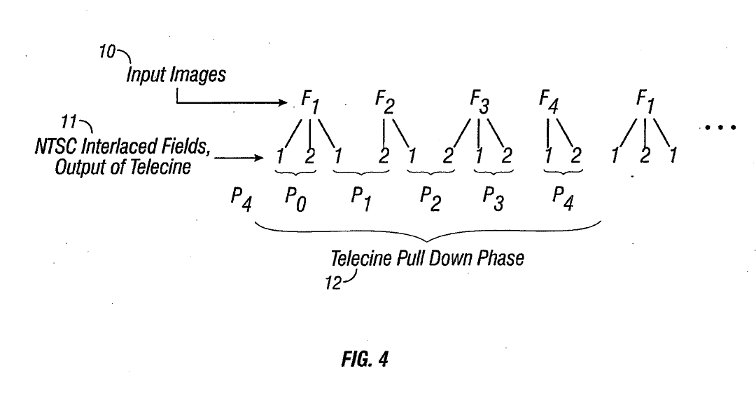

FIG. 4 shows the effect of telecining progressive frames that were converted to interlaced video. F₁, F₂, F₃, and F₄ are progressive images that are the input to a teleciner. The numbers “1” and “2” below the respective frames are indications of either odd or even fields. It is noted that some fields are repeated in view of disparities amongst the frame rates. FIG. 4 also shows pull-down phases P₀, P₁, P₂, P₃, and P₄. The phase P₀ is marked by the first of two NTSC compatible frames which have identical first fields. The following four frames correspond to phases P₁, P₂, P₃, and P₄. Note that the frames marked by P₂ and P₃ have identical second fields. Because film frame F₁ is scanned three times, two identical successive output NTSC compatible first fields are formed. All NTSC fields derived from film frame F₁ are taken from the same film image and therefore are taken at the same instant of time. Other NTSC frames derived from the film may have adjacent fields 1/24 sec apart.

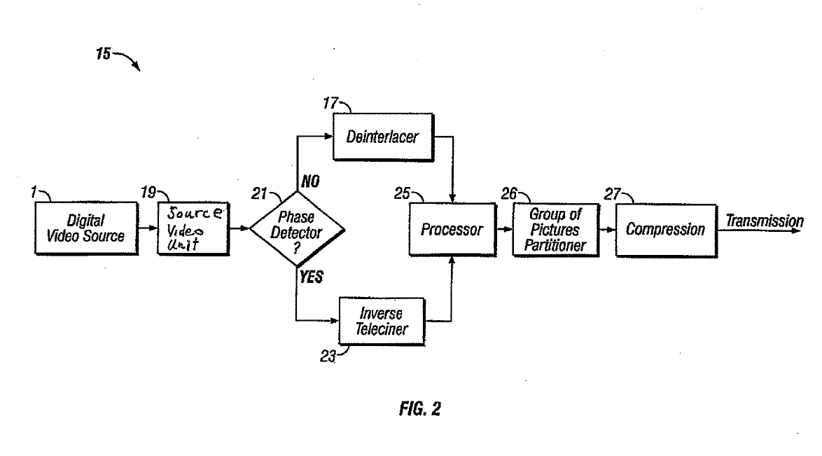

FIG. 2 is a block diagram illustrating a signal preparation unit 15. In one aspect, the signal preparation unit 15 may reside in the digital transmission facility of FIG. 1. In FIG. 2, signal preparation unit 15 used to prepare the data for transmission via the network 9. Video frames, recovered in source video unit 19, are passed to the phase detector 21. Phase detector 21 distinguishes between video that originated in a telecine and that which began in a standard broadcast format. If the decision is made that the video was telecined (the YES decision path exiting phase detector 21), the telecined video is returned to its original format in inverse telecine 23. Redundant frames are identified and eliminated and fields derived from the same video frame are rewoven into a complete image. Since the sequence of reconstructed film images were photographically recorded at regular intervals of 1/24 of a second, the motion estimation process performed in compression unit 27 is more accurate using the inverse telecined images rather than the telecined data, which has an irregular time base. Not shown in FIG. 2 is the additional data needed to perform the inverse telecine operation.

When conventional NTSC video is recognized (the NO path from phase detector 21), it is transmitted to deinterlacer 17 for compression, resulting in video fields that were recorded at intervals of 1/60 of a second. The phase detector 11 continuously analyzes video frames that stream from source 19 because different types of video may be received at any time. As an exemplary, video conforming to the NTSC standard may be inserted into the telecine's video output as a commercial. The decision made in phase detector 21 should be accurate. Processing conventionally originated NTSC as if it were telecined may cause a serious loss of the information in the video signal.

The signal preparation unit 15 also incorporates a group of pictures (GOP) partitioner 26, to adaptively change the composition of the group of pictures coded together. It is designed to assign one of four types of encoding frames (I, P, B or “Skip Frame”) to a plurality of video frames at its input, thereby removing much of the temporal redundancy while maintaining picture quality at the receiving terminal 3. The processing by the group of picture partitioner 26 and the compression module 27 is aided by preprocessor 25, which provides two dimensional filtering for noise removal.

In one aspect, the phase detector 21 makes certain decisions after receipt of a video frame. These decisions include: (i) whether the present video from a telecine output and the 3:2 pull down phase is one of the five phases P₀, P₁, P₂, P₃, and P₄ shown in definition 12 of FIG. 4; and (ii) the video was generated as conventional NTSC. That decision is denoted as phase P₅.

These decisions appear as outputs of phase detector 21 shown in FIG. 2. The path from phase detector 21 labeled “YES” actuates the inverse telecine 23, indicating that it has been provided with the correct pull down phase so that it can sort out the fields that were formed from the same photographic image and combine them. The path from phase detector 21 labeled “NO” similarly actuates the deinterlacer block to separate an apparent NTSC frame into fields for optimal processing.

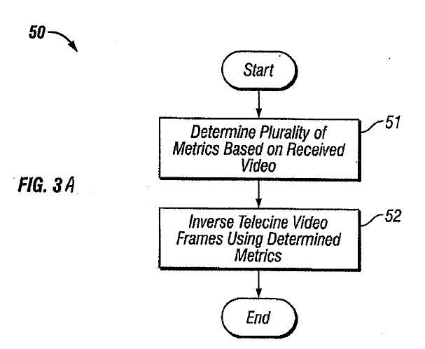

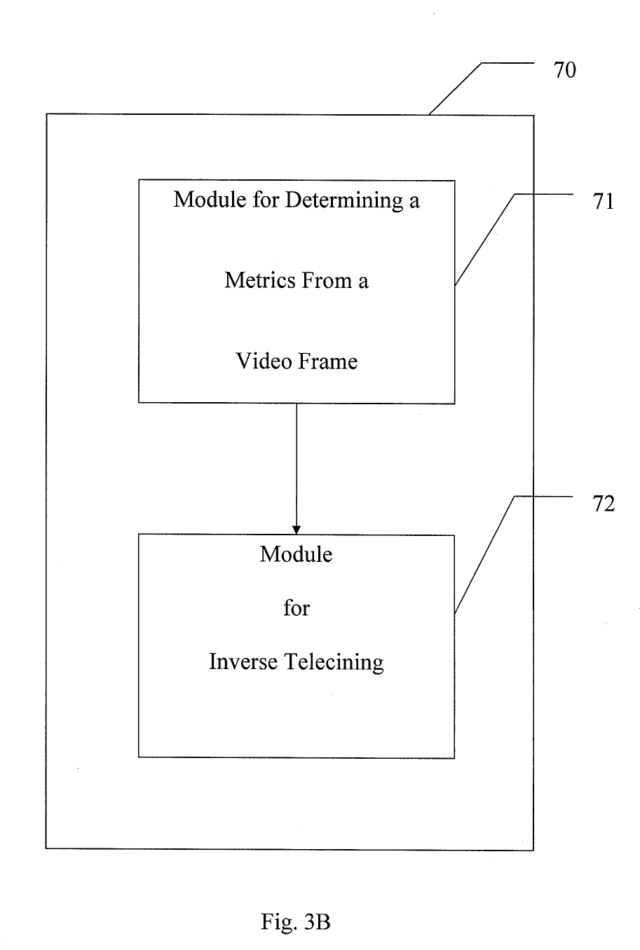

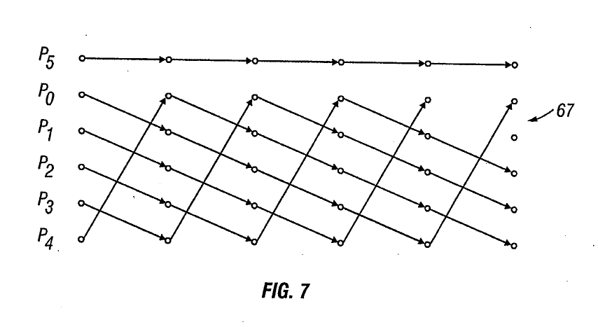

FIG. 3A is a flowchart illustrating a process 50 of inverse telecining a video stream. In one aspect, the process 50 is performed by the signal preparation unit 15 of FIG. 2. Starting at a step 51, the signal preparation unit 15 determines a plurality of metrics based upon the received video. In this aspect, four metrics are formed which are sums of differences between fields drawn from the same frame or adjacent frames in metrics determination unit 51. Note that the processing functions exhibited in 50 are replicated in the device 70 shown in FIG. 3B, which may be included in signal preparation unit 15. System structure 70 comprises a metrics determining module 71 and an inverse teleciner 72. The four metrics are further assembled in 51 into a Euclidian measure of distance between the four metrics derived from the received data and the most likely values of these metrics for each of the six hypothesized phases. The Euclidean sums are called branch information; for each received frame there are six such quantities. Each hypothesized phase has a successor phase which, in the case of the possible pull down phases, changes with each received frame. The possible paths of transitions are shown in FIG. 7 and denoted by 67. There are six such paths. The decision process maintains six measures equivalent to the sum of Euclidean distances for each path of hypothesized phases. To make the procedure responsive to changed conditions each Euclidean distance in the sum is diminished as it gets older. The phase track whose sum of Euclidean distances is smallest is deemed to be the operative one. The current phase of this track is called the “applicable phase.” Inverse telecining based on the phase selected, so long as it is not P₅, can now take place as shown in block 52. If P₅ is selected then the current frame is deinterlaced.

In summary, the applicable phase is either utilized as the current pull down phase, or as an indicator to command the deinterlace of a frame that has been estimated to have a valid NTSC format.

For every frame received from video input 19 in FIG. 2 a new value for each of four metrics is computed. These are defined as
SAD_{FS}=Σ|Current Field One Value(i,j)−Previous Field One Value(i,j)| (1)
SAD_{SS}=Σ|Current Field Two Value(i,j)−Previous Field Two Value(i,j)| (2)
SAD_{PO}=Σ|Current Field One Value(i,j)−Previous Field Two Value(i,j)| (3)
SAD_{CO}=Σ|Current Field One Value(i,j)−Current Field Two Value(i,j)| (4)

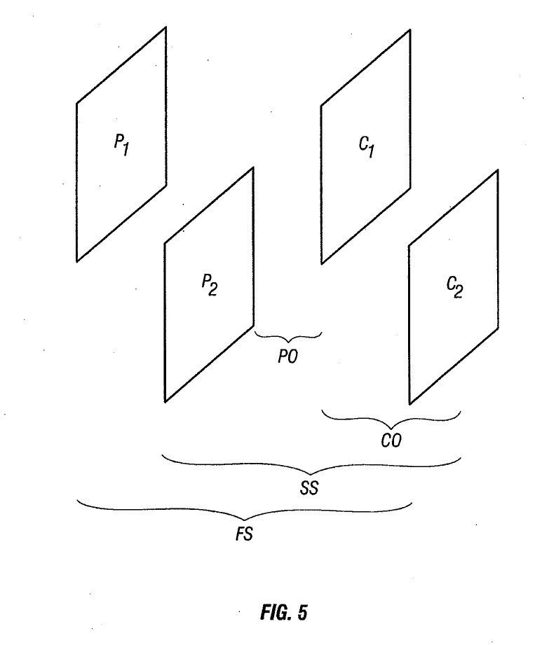

The term SAD is an abbreviation of the term “summed absolute differences.” The fields which are differenced to form the metrics are graphically shown in FIG. 5. The subscript refers to the field number; the letter denotes either Previous (=P) or Current (=C). The brackets in FIG. 5 refer to the pair-wise differencing of the fields. SAD_{FS} refers to differences between the field one of the current frame, labeled C₁, and field one of the previous frame, labeled P₁, which are spanned by a bracket labeled FS in definition provided in FIG. 5; SAD_{SS} refers to differences between the field two of the current frame, labeled C₂, and field two of the previous frame, labeled P₂, which are both spanned by a bracket labeled SS; SAD_{CO} refers to differences between field 2 of the current frame labeled C₂ and field one of the current frame, labeled C₁, which is spanned by a bracket labeled CO; and SAD_{PO} refers to differences between field one of the current frame and field 2 of the previous frame, which are both spanned by a bracket labeled PO.

The computational load to evaluate each SAD is described below. There are approximately 480 active horizontal lines in conventional NTSC. For the resolution to be the same in the horizontal direction, with a 4:3 aspect ratio, there should be 480×4/3=640 equivalent vertical lines, or degrees of freedom. The video format of 640×480 pixels is one of the formats accepted by the Advanced Television Standards Committee. Thus, every 1/30 of a second, the duration of a frame, 640×480=307,200 new pixels are generated. New data is generated at a rate of 9.2×10⁶ pixels/sec, implying that the hardware or software running this system processes data at approximately a 10 MByte rate or more. This is one of the high speed portions of the system. It can be implemented by hardware, software, firmware, middleware, microcode, or any combination thereof. The SAD calculator could be a standalone component, incorporated as hardware, firmware, middleware in a component of another device, or be implemented in microcode or software that is executed on the processor, or a combination thereof. When implemented in software, firmware, middleware or microcode, the program code or code segments that perform the calculation may be stored in a machine readable medium such as a storage medium. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents.

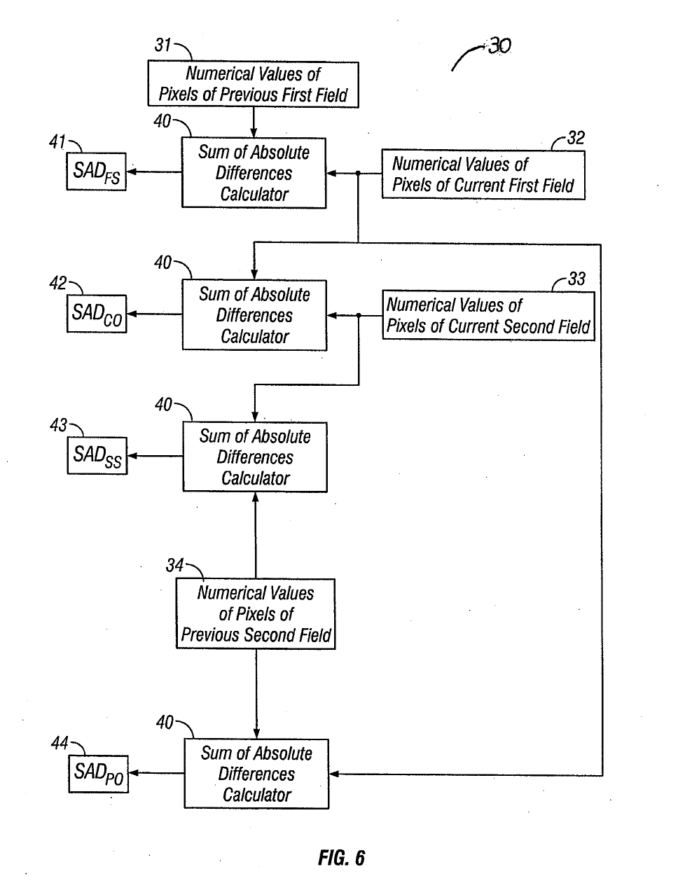

Flowchart 30 in FIG. 6 makes explicit the relationships in FIG. 5 and is a graphical representation of Eqs. 1-4. It shows storage locations 41, 42, 43, and 44 into which are kept the most recent values of SAD_{FS}, SAD_{CO}, SAD_{SS} and SAD_{PO} respectively. These are each generated by four sum of absolute differences calculators 40, which process the luminance values of previous first field data 31, luminance values of current first field data 32, luminance values of current second field data 33 and luminance values of the previous second field data 34. In the summations that define the metrics, the term “value(i,j)” is meant to be the value of the luminance at position i,j, the summation being over all active pixels, though summing over the a meaningful subset of active pixels is not excluded.

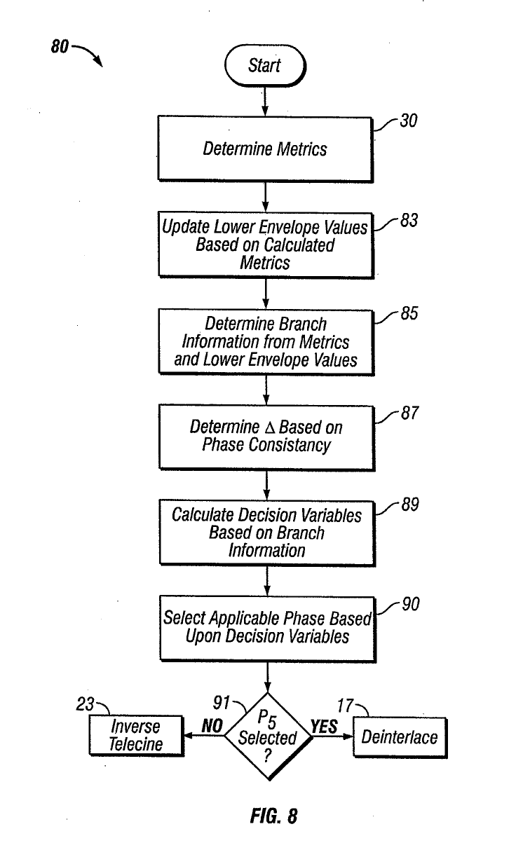

Flowchart 80 in FIG. 8 is a detailed flowchart illustrating the process for detecting telecined video and inverting it to recover to the original scanned film image. In step 30 the metrics defined in FIG. 6 are evaluated. Continuing to step 83, lower envelope values of the four metrics are found. A lower envelope of a SAD metric is a dynamically determined quantity that is the highest numerical floor below which the SAD does not penetrate. Continuing to step 85 branch information quantities defined below in Eqs. 5-10 are determined in light of previously determined metrics, the lower envelope values and an experimentally determined constant A. Since the successive values of the phase may be inconsistent, a quantity Δ is determined to reduce this apparent instability in step 87. The phase is deemed consistent when the sequence of phase decisions is consistent with the model of the problem shown in FIG. 7. Following that step, we proceed to step 89 to calculate the decision variables using the current value of Δ. Decision variables calculator 89 evaluates decision variables using all the information generated in the blocks of 80 that led to it. Steps 30, 83, 85, 87, and 89 are an expansion of metrics determination 51 in FIG. 3. From these variables, the applicable phase is found by phase selector 90. Decision step 91 uses the applicable phase to either invert the telecined video or deinterlace it as shown. It is a more explicit statement of the operation of phase detector 21 in FIG. 2. In one aspect the processing of FIG. 8 is performed by the phase detector 21 of FIG. 2. Starting at step 30, detector 21 determines a plurality of metrics by the process described above with reference to FIG. 5, and continues through steps 83, 85, 87, 89, 90, and 91.

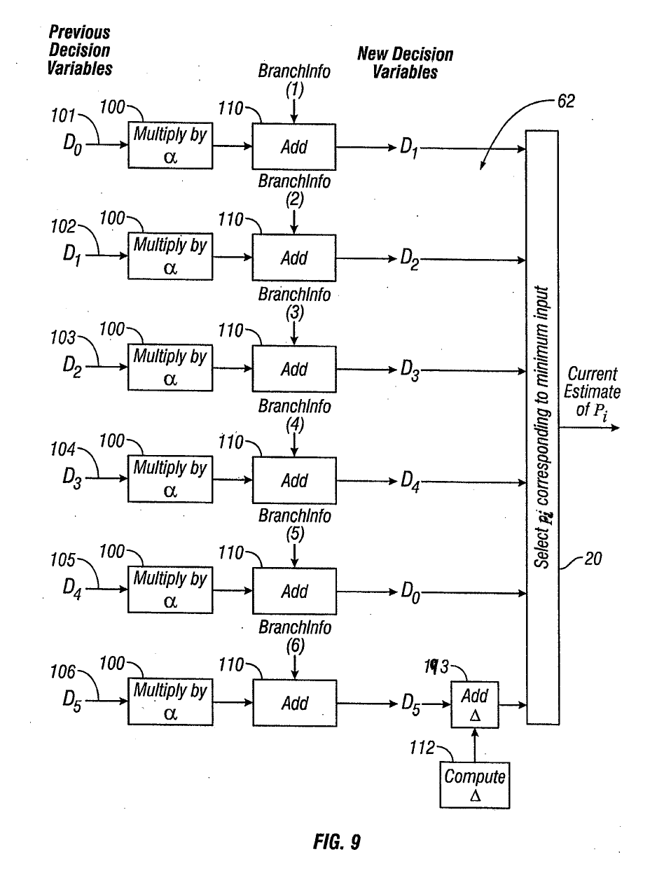

Flowchart 80 illustrates a process for estimating the current phase. The flowchart at a step 83 describes the use of the determined metrics and lower envelope values to compute branch information. The branch information may be recognized as the Euclidean distances discussed earlier. Exemplary equations that may be used to generate the branch information are Eqs. 5-10 below. The Branch Info quantities are computed in block 109 of FIG. 9.

The processed video data can be stored in a storage medium which can include, for example, a chip configured storage medium (e.g., ROM, RAM) or a disc-type storage medium (e.g., magnetic or optical) connected to the processor 25. In some aspects, the inverse telecine 23 and the deinterlacer 17 can each contain part or all of the storage medium. The branch information quantities are defined by the following equations.
Branch Info(0)=(SAD_{FS}−H_{S})²+(SAD_{SS}−H_{S})²+(SAD_{PO}−H_{P})²+(SAD_{CO}−L_{C})² (5)
Branch Info(1)=(SAD_{FS}−L_{S})²+(SAD_{SS}−H_{S})²+(SAD_{PO}−L_{P})²+(SAD_{CO}−H_{C})² (6)
Branch Info(2)=(SAD_{FS}−H_{S})²+(SAD_{SS}−H_{S})²+(SAD_{PO}−L_{P})²+(SAD_{CO}−H_{C})² (7)
Branch Info(3)=(SAD_{FS}−H_{S})²+(SAD_{SS}−L_{S})²+(SAD_{PO}−L_{P})²+(SAD_{CO}−L_{C})² (8)
Branch Info(4)=(SAD_{FS}−H_{S})²+(SAD_{SS}−H_{S})²+(SAD_{PO}−H_{P})²+(SAD_{CO}−L_{C})² (9)
Branch Info(5)=(SAD_{FS}−L_{S})²+(SAD_{SS}−L_{S})²+(SAD_{PO}−L_{P})²+(SAC_{CO}−L_{C})² (10)

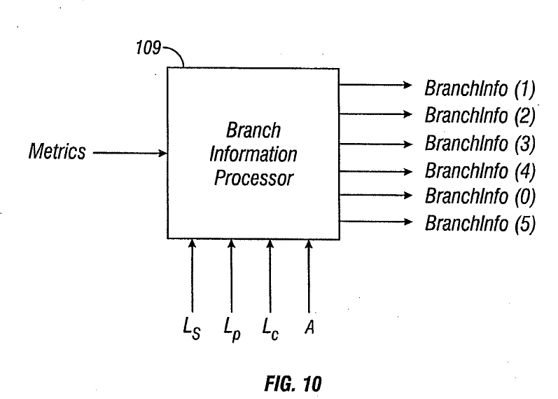

The fine detail of the branch computation is shown in branch information calculator 109 in FIG. 10. As shown in calculator 109 developing the branch information uses the quantities L_{S}, the lower envelope value of SAD_{FS} and SAD_{SS}, L_{P}, the lower envelope value of SAD_{PO}, and L_{C}, the lower envelope value of SAD_{CO}. The lower envelopes are used as distance offsets in the branch information calculations, either alone or in conjunction with a predetermined constant A to create H_{S}, H_{P} and H_{C}. Their values are kept up to date in lower envelope trackers described below. The H offsets are defined to be
H_{S}=L_{S}+A (11)
H_{PO}=L_{P}+A (12)
H_{C}=L_{C}+A (13)

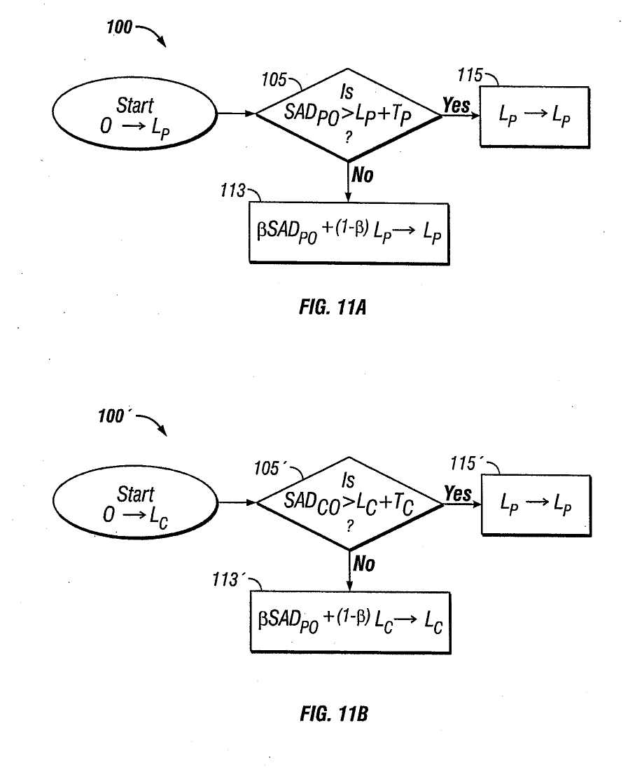

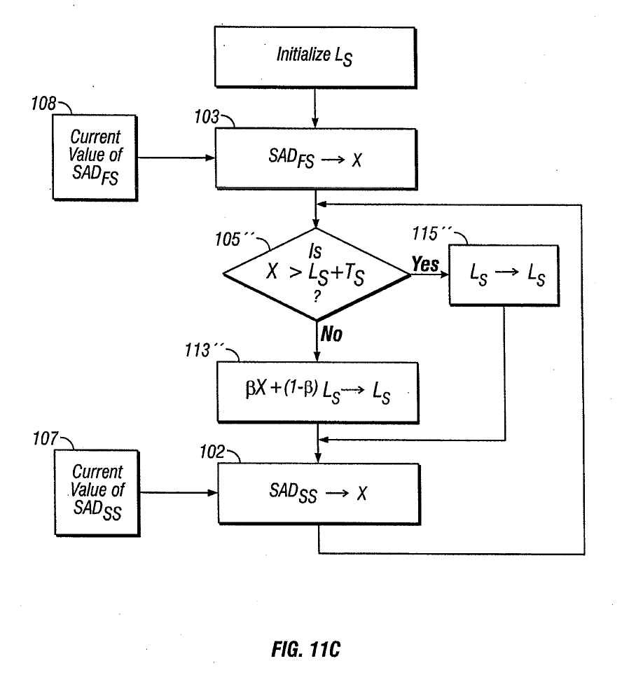

A process of tracking the values of L_{S}, L_{P}, and L_{C} is presented in FIGS. 11A, 11B, and 11C. Consider, for example, the tracking algorithm for L_{P} 100 shown at the top of FIG. 11A. The metric SAD_{PO} is compared with the current value of L_{P} plus a threshold T_{P} in comparator 105. If it exceeds it, the current value of L_{P} is unchanged as shown in block 115. If it does not, the new value of L_{P} becomes a linear combination of SAD_{PO} and L_{P} as seen in block 113. In another aspect for block 115 the new value of L_{P} is L_{P}+T_{P}.

The quantities L_{S} and L_{C} in FIGS. 11B and 11C are similarly computed. Processing blocks in FIGS. 11A, 11B, and 11C which have the same function are numbered identically but given primes (′ or ″) to show that they operate on a different set of variables. For example, when a linear combination of the SAD_{PO} and L_{C} are formed, that operation is shown in block 113′. As is the case for L_{P}, another aspect for 115′ would replace L_{C} by L_{C}+T_{C}.

In the case of L_{S}, however, the algorithm in FIG. 11B processes SAD_{FS} and SAD_{SS} alternately, in turn labeling each X, since this lower envelope applies to both variables. The alternation of SAD_{FS} and SAD_{SS} values takes place when the current value of SAD_{FS} in block 108 is read into the location for X in block 103, followed by the current value of SAD_{SS} in 107 being read into the location for X in block 102. As is the case for L_{P}, another aspect for 115″ would replace L_{S} by L_{S}+T_{S}. The quantity A and the threshold values used in testing the current lower envelope values are predetermined by experiment.

FIG. 9 is a flowchart illustrating an exemplary process for performing step 89 of FIG. 8. FIG. 9 generally shows a process for updating the decision variables. There the six decision variables (corresponding to the six possible decisions) are updated with new information derived from the metrics. The decision variables are found as follows:
D₀=αD₄+Branch Info(0) (14)
D₁=αD₀+Branch Info(1) (15)
D₂=αD₁+Branch Info(2) (16)
D₃=αD₂+Branch Info(3) (17)
D₄=αD₃+Branch Info(4) (18)
D₅=αD₅+Branch Info(5) (19)

The quantity α is less than unity and limits the dependence of the decision variables on their past values; use of α is equivalent to diminishing the effect of each Euclidean distance as its data ages. In flowchart 62 the decision variables to be updated are listed on the left as available on lines 101, 102, 103, 104, 105, and 106. Each of the decision variables on one of the phase transition paths is then multiplied by α, a number less than one in one of the blocks 100; then the attenuated value of the old decision variable is added to the current value of the branch info variable indexed by the next phase on the phase transition path that the attenuated decision variable was on. This takes place in block 110. Variable D₅ is offset by a quantity Δ in block 193; Δ is computed in block 112. As described below, the quantity is chosen to reduce an inconsistency in the sequence of phases determined by this system. The smallest decision variable is found in block 20.

In summary, new information specific to each decision is added to the appropriate decision variable's previous value that has been multiplied by α, to get the current decision variable's value. A new decision can be made when new metrics are in hand; therefore this technique is capable of making a new decision upon receipt of fields 1 and 2 of every frame. These decision variables are the sums of Euclidean distances referred to earlier.

The applicable phase is selected to be the one having the subscript of the smallest decision variable. A decision based on the decision variables is made explicitly in block 90 of FIG. 8. Certain decisions are allowed in decision space. As described in block 91, these decisions are: (i) The applicable phase in not P₅. Inverse telecine the video. (Not shown is the use of the applicable phase to guide the inverse telecining process.) and (ii) The applicable phase is P₅. Deinterlace the video.

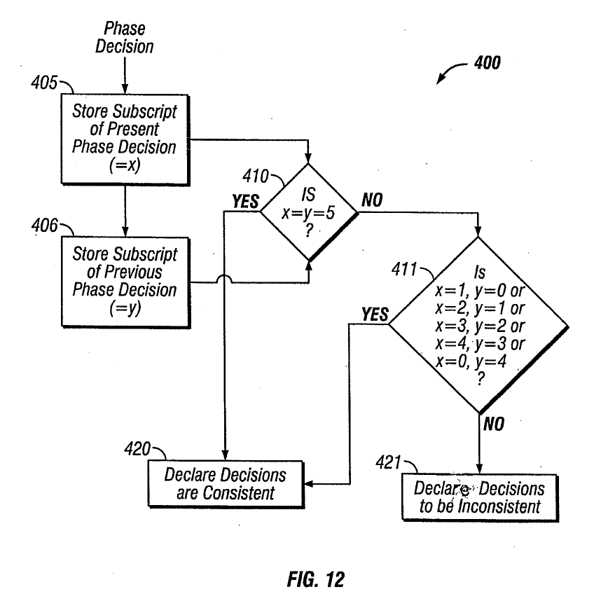

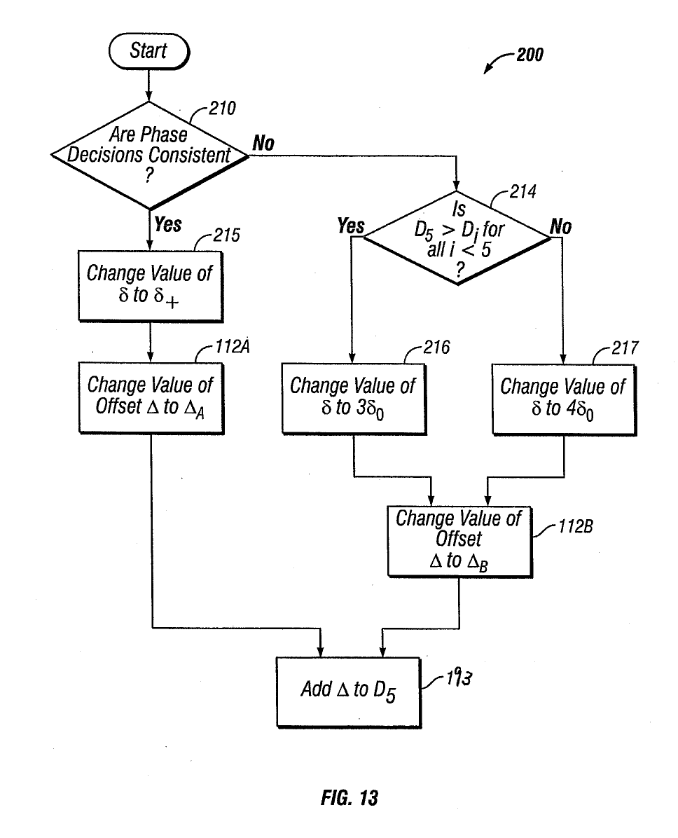

Each phase can be regarded as a possible state of a finite state machine, with transitions between the states dependent on the current values of the decision variables and the six branch information quantities. When the transitions follow the pattern
P₅→P₅ or P₀→P₁→P₂→P₃→P₄ or P₅→P₅→P₅→P₃→P₄→P₀
the machine is operating properly. There may be occasional errors in a coherent string of decisions, because the metrics are drawn from video, which is inherently variable. This technique detects phase sequences that are inconsistent with FIG. 7. Its operation is outlined in FIG. 12. The algorithm 400 stores the subscript of the present phase decision (=x) in block 405 and the subscript of the previous phase decision (=y) in block 406. In block 410 x=y=5 is tested; in block 411 the following
x=1,y=0 or
x=2,y=1 or
x=3,y=2 or
x=4,y=3 or
x=0,y=4
are tested. If either test is in the affirmative, the decisions are declared to be consistent in block 420. If neither test is affirmative, an offset, shown in block 193 of FIG. 9 is computed in FIG. 13 and added to D₅, the decision variable associated with P₅.

The modification to D₅ also appears in FIG. 13 as part of process 200, which provides corrective action to inconsistencies in a sequence of phases. Suppose the consistency test in block 210 in flowchart 200 has failed. Proceeding along the “No” branch that leads from block 210, the next test in block 214 is whether D₅>Dᵢ for all i<5, or alternatively is at least one of the variables, Dᵢ, for i<5, bigger than D₅. If the first case is valid, a parameter δ, whose initial value is δ₀, is changed to 3δ₀ in block 216. If the second case is valid, then δ is changed to 4δ₀ in block 217. In block 112B, the value of Δ is updated to be Δ_{B}, where
Δ_{B}=max(Δ−δ, −40δ₀) (20)

Returning again to block 210, assume that the string of decisions is judged to be consistent. The parameter δ is changed to δ₊ in block 215, defined by
δ₊=max(2δ, 16δ₀) (21)

The new value of δ is inserted into Δ_{A}, the updating relationship for Δ in block 112A. This is
Δ_{A}=max(Δ+δ, 40δ₀) (22)
Then the updated value of Δ is added to decision variable D₅ in block 193.

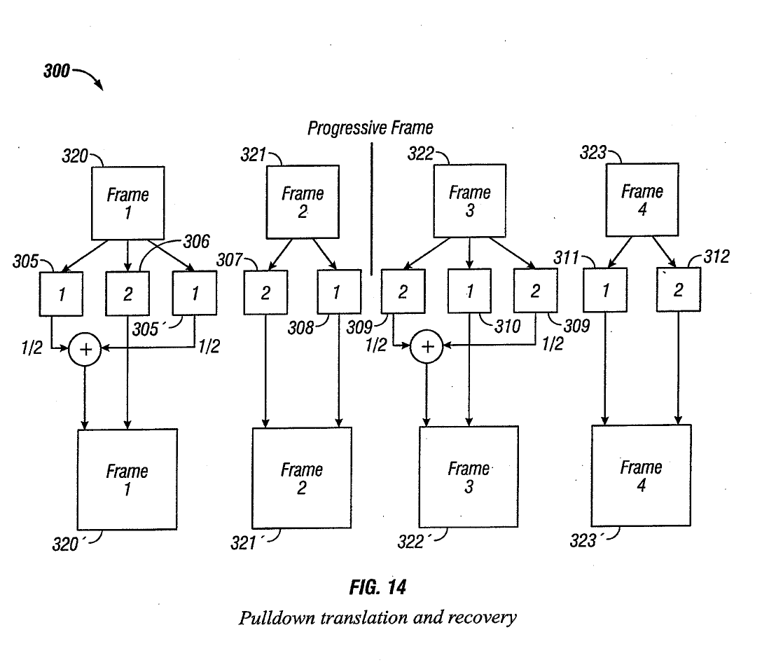

FIG. 14 shows how the inverse telecine process proceeds in system 301 once the pull down phase is determined. With this information fields 305 and 305′ are identified as representing the same field of video. The two fields are averaged together, and combined with field 306 to reconstruct frame 320. The reconstructed frame is 320′. A similar process would reconstruct frame 322. Fields derived from frames 321 and 323 are not duplicated. These frames are reconstructed by reweaving their first and second fields together.

In the aspect described above, every time a new frame is received four new values of metrics are found and a six fold set of hypotheses is tested using newly computed decision variables. Other processing structures could be adapted to compute the decision variables. A Viterbi decoder adds the metrics of the branches that make up the paths together to form the path metric. The decision variables defined here are formed by a similar rule: each is the “leaky” sum of new information variables. (In a leaky summation the previous value of a decision variable is multiplied by a number less than unity before new information data is added to it.) A Viterbi decoder structure could be modified to support the operation of this procedure.

While the present aspect is described in terms of processing conventional video in which a new frame appears every 1/30 second, it is noted that this process may be applied to frames which are recorded and processed backwards in time. The decision space remains the same, but there are minor changes that reflect the time reversal of the sequence of input frames. For example, a string of coherent telecine decisions from the time-reversed mode (shown here)
P₄ P₃ P₂ P₁ P₀
would also be reversed in time.

Using this variation on the first aspect would allows the decision process two tries—one going forward in time, the other backward—at making a successful decision. While the two tries are not independent, they are different in that each try would process the metrics in a different order.

This idea could be applied in conjunction of a buffer maintained to store future video frames for processing. If a video segment is found to give unacceptably inconsistent results in the forward direction of processing, the procedure would draw future frames from the buffer and attempt to get over the difficult stretch of video by processing frames in the reverse direction.

The processing of video described in this patent can also be applied to video in the PAL format.

It is noted that the aspects may be described as a process which is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

It should also be apparent to those skilled in the art that one or more elements of a device disclosed herein may be rearranged without affecting the operation of the device. Similarly, one or more elements of a device disclosed herein may be combined without affecting the operation of the device. Those of ordinary skill in the art would understand that information and signals may be represented using any of a variety of different technologies and techniques. Those of ordinary skill would further appreciate that the various illustrative logical blocks, modules, and algorithm steps described in connection with the examples disclosed herein may be implemented as electronic hardware, firmware, computer software, middleware, microcode, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed methods.

The steps of a method or algorithm described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

In addition, the various illustrative logical blocks, components, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples and additional elements may be added without departing from the spirit or scope of the disclosed method and apparatus. The description of the aspects is intended to be illustrative, and not to limit the scope of the claims.

What is claimed is:

1. A method of processing a plurality of video frames comprising:
determining a plurality of metrics from said video frames; and
inverse telecining said video frames using the determined metrics.

2. The method of claim 1, wherein inverse telecining comprises estimating a pull-down phase.

3. The method of claim 1, wherein determining comprises:
determining a first metric indicative of any differences between a first field of a first frame in the plurality of video frames and a first field of a second frame in the plurality of video frames, the first frame following the second frame in time;
determining a second metric indicative of any differences between a second field of a first frame and a second field of a second frame;
determining a third metric indicative of any differences between the first field of the first frame and the second field of the second frame; and
determining a fourth metric indicative of any differences between the first field of the first frame and the second field of the first frame, and wherein at least one of said first, second, third and fourth metrics indicates a pull-down phase.

4. The method of claim 3, wherein at least one of the four metrics indicates that at least one of the video frames has not been telecined and conforms to a broadcast standard.

5. The method of claim 3, wherein said first metric comprises a sum of absolute differences (SAD_{FS}) between said first field of the first frame and said first field of the second frame, said second metric comprises a sum of absolute differences (SAD_{SS}) between said second field of said first frame and said second field of said second frame, said third metric comprises a sum of absolute differences (SAD_{PO}) between said first field of said first frame and said second field of said second frame; and said fourth metric comprises a sum of absolute differences (SAD_{CO}) between said first field of said first frame and said second field of said first frame.

6. The method of claim 5, further comprising computing lower envelope levels of SAD_{FS} and SAD_{SS} and lower envelope levels of SAD_{PO} and SAD_{CO}.

7. The method of claim 3, wherein determining further comprises computing branch information from the said four metrics.

8. The method of claim 1, wherein determining comprises:
determining a plurality of metrics for each video frame in the plurality of video frames
determining branch information from said metrics; and
determining decision variables from the branch information, and wherein inverse telecining the video frames further comprises identifying an applicable phase for each video frame.

9. The method of claim 8, wherein the applicable phase indicates whether at least one of the video frames in said plurality of video frames has been telecined, or conforms to a broadcast standard.

10. The method of claim 9, wherein inverse telecining comprises using the applicable phase as a pull-down phase for inverse telecining.

11. The method of claim 10, further comprising detecting an inconsistency in the applicable phase.

12. The method of claim 11, further comprising reducing the detected inconsistency by adjusting the offset to at least one decision variable.

13. The method of claim 8, further comprising determining the decision variables in a Viterbi-like decoder.

14. The method of claim 1, further comprising averaging at least the duplicated fields in the video frames.

15. The method of claim 8, further comprising determining a pull-down phase via a state machine.

16. An apparatus for processing a plurality of video frames comprising:
a computational module configured to determine a plurality of metrics from said video frames; and
a phase detector configured to inverse telecine said video frames using the determined metrics.

17. The apparatus of claim 16, wherein the phase detector is further configured to estimate a pull-down phase.

18. The apparatus of claim 16, wherein the computational module is configured to:
determine a first metric indicative of any differences between a first field of a first frame in the plurality of video frames and a first field of a second frame in the plurality of video frames, the first frame following the second frame in time;
determine a second metric indicative of any differences between a second field of a first frame and a second field of a second frame;
determine a third metric indicative of any differences between the first field of the first frame and the second field of the second frame; and
determine a fourth metric indicative of any differences between the first field of the first frame and the second field of the first frame, and wherein the phase detector uses at least one of said first, second, third and fourth metrics to indicate a pull-down phase.

19. The apparatus of claim 18, wherein the phase detector uses at least one of the four metrics determined by the computational module to indicate that at least one of the video frames has not been telecined and conforms to a broadcast standard.

20. The apparatus of claim 16, wherein the computational module is configured to:
determine a plurality of metrics for each video frame in the plurality of video frames;
determine a branch information from said metrics; and
determine decision variables from the branch information.

21. The apparatus of claim 20, wherein a phase detector is configured to identify an applicable phase based on the decision variables for each video frame.

22. The apparatus of claim 21, wherein the phase detector is configured to indicate, based on the applicable phase, whether a video frame has been telecined, or conforms to a broadcast standard.

23. The apparatus of claim 22, wherein the phase detector is configured to inverse telecine the video frames by identifying the applicable phase as a pull down phase.

24. The apparatus of claim 20, wherein the computational module further comprises state machine that determines a pull-down phase.

25. An apparatus for processing a plurality of video frames comprising:
means for determining a plurality of metrics from said video frames; and
means for inverse telecining said video frames using the determined metrics.

26. The apparatus of claim 25, wherein the inverse telecining means inverse telecines the video frames based on a pull-down phase.

27. The apparatus of claim 25, wherein the means for inverse telecining uses at least one of four metrics to indicate that at least one of the video frames has not been telecined and conforms to a broadcast standard.

28. The apparatus of claim 25, wherein the means for determining the metrics comprises:
means for determining the plurality of metrics for each video frame in said plurality of video frames;
means for determining branch information from said metrics; and
means for determining decision variables from the branch information, and wherein the means for inverse telecining the video comprises a means for identifying an applicable phase for each video frame based on the decision variables.

29. The apparatus of claim 28, wherein the means for identifying the applicable phase includes a means for indicating whether the video has been telecined, or conforms to a broadcast standard.

30. The apparatus of claim 29, wherein the means for inverse telecining identifies the applicable phase as a pull-down phase for inverse telecining.

31. The apparatus of claim 30, wherein the means for identifying the applicable phase includes means for detecting an inconsistency in the values of the applicable phase.

32. The apparatus of claim 28, wherein the means for determining a pull-down phase comprises a state machine.

33. A machine readable medium comprising instructions for processing a plurality of video frames, wherein the instructions upon execution cause a machine to:
determine a plurality of metrics from the plurality of video frames; and
inverse telecine the video frames using the determined metrics.

34. The machine readable medium of claim 33, wherein the instructions further cause the machine to:
determine a plurality of metrics for each video frame in said plurality of video frames;
determine branch information from said metrics; and
determine decision variables from the branch information, wherein the instructions that cause the machine to inverse telecine of the video frames further cause the machine to identify an applicable phase of video frames based upon the decision variables.

35. The machine readable medium of claim 34, wherein the instructions that cause the machine to identify the applicable phase further cause the machine to indicate whether the video has been telecined or conforms to a broadcast standard.

36. The machine readable medium of claim 35, wherein the instructions further cause the machine to determine a pull-down phase for inverse telecining one of the plurality of the video frames.

37. The machine readable medium of claim 34, wherein the instructions further cause the machine to determine a pull-down phase by operating as a state machine.

38. A video encoding processor configured to:
determine a plurality of metrics from a plurality of video frames; and
inverse telecine the video frames using the determined metrics.

39. The video encoding processor of claim 38, wherein the processor inverse telecines by determining a pull-down phase.

40. The video encoding processor of claim 38, wherein at least fields that are duplicated in the video frames are averaged together by the processor to form the inverse telecine output.
